(19) United States
(12) Patent Application Publication
(10) Pub. No.: US 2004/0134002 A1
(43) Pub. Date: Jul. 15, 2004

(54) Dental brush for use on a rotary dental hand piece

(75) Inventor: Stefan Zimmer, Berlin (DE)

Correspondence Address: WOOD, HERRON & EVANS, LLP, 2700 CAREW TOWER, 441 VINE STREET, CINCINNATI, OH, 45202, US

(73) Assignee: KerrHawe SA

(21) Appl. No.: 10/624,238

(22) Filed: Jul. 22, 2003

(30) Foreign Application Priority Data
Jul. 23, 2002 (CH) 2002 1302/02

(51) Int. Cl. A61C 17/26; A46B 7/08

(52) U.S. Cl. 15/28; 15/180; 15/DIG. 5

(57) ABSTRACT

The brush for use on a dental rotary hand piece comprises a bristle field in which the length of the bristles decreases from the external radius of the bristle field towards its center. A brush of this kind allows improved finishing, polishing, and cleaning of interdental spaces and fissures in the chewing surface.

### FIELD OF THE INVENTION

The present invention refers to a dental brush for use on a dental rotary hand piece or on an electric toothbrush, and comprising a bristle field. A large number of rotary brushes used for finishing, polishing, and cleaning teeth and/or fillings are known in the art. The bristle field of these brushes, which is formed of individual bristles, may be designed in various manners and may e.g. be full or only comprise crowns of bristles.

Recently, brushes have been successfully used instead of rotary polishers, thereby reducing the number of operations required after diamond finishing, on one hand, and ideally allowing to use a single polishing tool for all tooth surfaces independently of their geometry or their accessibility.

### PRIOR ART

U.S. Pat. No. 4,020,522 and U.S. Pat. No. 4,739,532 are mentioned as examples of a crown-shaped arrangement of bristles, whose length decreases from the interior to the exterior of the bristle field. Brushes of this kind are mainly used for disinfecting periodontal pockets, where the bristles must be relatively soft.

Brushes whose bristle fields are plane, i.e. where all bristles are cut to the same length, are also known in the art. This also applies to crown-shaped arrangements of bristles having the same length, as marketed by the applicant of the present invention.

These arrangements of the bristles are disadvantageous in that they do not reach well into spaces, and that they do not allow a complete finishing, polishing, grinding, or cleaning particularly of narrow gaps or fissures, see FIG. 1. If the bristles are close to each other, such an arrangement will result in a wedging effect in acutely tapering interdental spaces and fissures in chewing surfaces.

Furthermore, WO 99/45819 discloses a toothbrush for daily use comprising, as seen in the transversal direction, a bristle field composed of concavely arranged bristle bundles. Inter alia, this provides a better retention of toothpaste applied thereon.

### SUMMARY OF THE INVENTION

On the background of this prior art, it is the object of the present invention to provide a brush for use on a dental rotary hand piece or on an electric toothbrush that allows a more effective finishing, polishing, and cleaning of interdental spaces and fissures in the chewing surfaces of the teeth and of fillings. This object is attained by a brush wherein the length of the bristles of the bristle field decreases from the external diameter of the bristle field to its center.

### BRIEF DESCRIPTION OF THE DRAWINGS

Hereinafter, the invention will be explained in more detail with reference to drawings of exemplifying embodiments.

FIG. 1 shows an enlarged view of a brush of the prior art applied to an interdental space;

FIG. 2 shows a lateral, partly sectioned view of a first exemplifying embodiment of a brush of the invention;

FIG. 3 shows an alternative embodiment;

FIG. 4 shows an enlarged view of a brush of the invention in the position FIG. 1;

FIG. 5 shows a partially sectioned view of the brush of FIG. 2 applied to an interdental space; and

FIG. 6 shows the brush of FIG. 5 applied to a tooth.

### DETAILED DESCRIPTION OF PREFERRED EMBODIMENTS

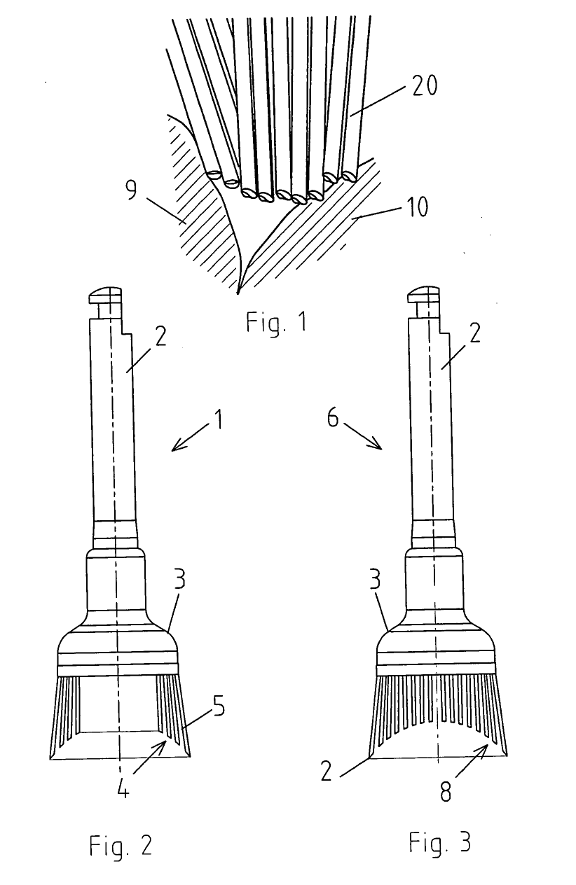

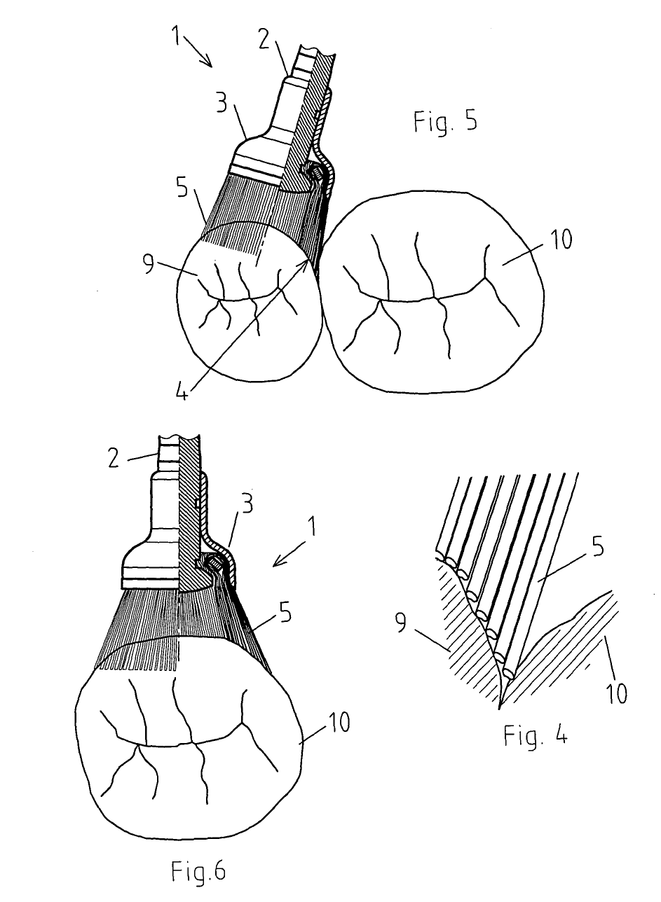

In FIG. 1 it appears that bristles 20 cannot fully reach into the space between teeth 9 and 10 or into a fissure. In contrast thereto, as appears in FIG. 4, the bristles 5 or 7 of the brush of the invention can reach deep into the space or the fissure.

The brush of the invention according to FIG. 2 essentially consists of fastening portion 2 for its attachment to a dental rotary hand piece or electric tooth brush and of a brush head 3 with bristle field 4 composed of individual bristles 5. As appears in FIGS. 2 and 4 to 6, the bristles of this exemplifying embodiment are arranged in the shape of a crown, and the length of the bristles decreases from the external surface of the bristle field to the interior thereof, i.e. they form a concave shape.

The decrease may be linear or result in a cambered shape, i.e. spherical or according to another geometrical shape. According to the intended use, individual bristles 5, which may be rounded, may comprise grinding materials, e.g. of aluminum oxide, silicon carbide, diamond, or calcium carbonate, or they may be used with a prophylactic paste. Furthermore, the bristles may be produced from different materials that are known per se, the applied material depending on the intended use, i.e. whether rotary brush 5 will be used for prophylactics or for finishing, polishing, or grinding teeth or dental restorations, or for other applications.

The concave shape formed by the bristles results in a less aggressive effect of the brush on soft portions such as the gums and a better adaptation to the tooth surface. In addition, an increased efficiency is obtained specifically because of the rotational movement of the brush as several bristles are in planar contact.

According to FIG. 3, the bristles 7 of brush 6 may be arranged otherwise than in the shape of a crown, i.e. they may be arranged in a full bristle field 8 while here also the length of the individual bristles decreases from the external surface of the bristle field towards the interior thereof in order to form either an inwardly conical or spherical surface.

Intense tests have shown that the Use of brushes with an inwardly hollow bristle field as described above yield good results particularly for finishing, polishing, and cleaning fissures and narrow interdental spaces, which is visible particularly in FIGS. 4 and 5 where, in contrast to a brush of the prior art as shown in FIG. 1, the longer external bristles may penetrate in a space between teeth 9 and 10 or in a fissure without being wedged therein.

FIG. 5 further shows that the concave shape of the bristle field is better adapted to the convex tooth surface, thereby providing a better finishing, cleaning, or polishing effect.

The brushes may also be used together with commercially available polishing pastes for professional prophylactic applications and provide the same advantages as described above. The result is a simplification of the procedure in the sense that only one brush is required and a pointed shape such as the small cup need not be applied. The concave crown shape furthermore results in an increase of the revolving speed as the crown is distanced from the center of rotation, thereby providing an increased efficiency. The concave brush may also be used for apparatus such as electric rotary toothbrushes, e.g. for home use.

1. A dental brush for use on a dental rotary hand piece or on an electric toothbrush, comprising a bristle field, wherein the length of the bristles of the bristle field decreases from the external radius of the bristle filed to its center.

2. The brush of claim 1, wherein the bristles are arranged in a crown.

3. The brush of claim 1, wherein the bristle field extends over the entire surface essentially.

4. The brush of claim 1, wherein the bristles are made of a thermally resistant synthetic material such as Aramide fibers, Kevlar fibers, or PEEK.

5. The brush of claim 1, wherein the bristles are comprise abrasive materials.

6. Use of the brush of claim 1 for finishing, polishing, or cleaning the tooth surface and/or a filling.

7. The Use of claim 6 on different filling materials.

8. Use of the brush of claim 1, wherein the brush includes polyamide fibers, and wherein a prophylactic paste is used.
